(19) United States
(12) Patent Application Publication
(10) Pub. No.: US 2026/0220964 A1
(43) Pub. Date: Jul. 30, 2026

(54) COMPUTER-IMPLEMENTED METHOD OF DETECTING FINGERTIP IN AN IMAGE, APPARATUS FOR DETECTING FINGERTIP IN AN IMAGE, AND COMPUTER-PROGRAM PRODUCT

(71) Applicants: Beijing BOE Technology Development Co., Ltd., Beijing (CN); BOE Technology Group Co., Ltd., Beijing (CN)

(72) Inventors: Xiaojun Tang, Beijing (CN); Jingru Wang, Beijing (CN)

(73) Assignees: Beijing BOE Technology Development Co., Ltd., Beijing (CN); BOE Technology Group Co., Ltd., Beijing (CN)

(21) Appl. No.: 19/577,934

(22) Filed: Mar. 25, 2026

Related U.S. Application Data
(63) Continuation of application No. PCT/CN2023/122453, filed on Sep. 28, 2023.

(51) Int. Cl. G06V 40/10; G06V 10/44; G06V 10/74; G06V 10/98

(52) U.S. Cl. CPC G06V 40/11; G06V 10/443; G06V 10/761; G06V 10/993

(57) ABSTRACT

A computer-implemented method of detecting fingertip in an image is provided. The computer-implemented method includes obtaining a contour of a hand in the image; and performing finger detection on the contour to obtain finger position information. Performing finger detection includes performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information.

### CROSS-REFERENCE TO RELATED APPLICATION

This application is a continuation of International Application No. PCT/CN2023/122453, filed Sep. 28, 2023, the contents of which are incorporated by reference in the entirety.

### TECHNICAL FIELD

The present invention relates to image recognition technology, more particularly, to a computer-implemented method of detecting fingertip in an image, an apparatus for detecting fingertip in an image, and a computer-program product.

### BACKGROUND

In the field of human-computer interaction, the accurate and efficient detection of fingertips plays a vital role in enabling natural and intuitive interaction between users and computer systems. Fingertip detection is a fundamental step in various applications, including gesture recognition, touch-based interfaces, virtual reality, and augmented reality.

### SUMMARY

In one aspect, the present disclosure provides a computer-implemented method of detecting fingertip in an image, comprising obtaining a contour of a hand in the image; and performing finger detection on the contour to obtain finger position information; wherein performing finger detection comprises performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information.

Optionally, performing candidate finger search based on at least the far point and the second point to obtain candidate finger information comprises assigning the far point as a first root point; assigning the second point as a top point; and searching for a second root point; wherein searching for the second root point comprises selecting a point on the contour as an updated candidate second root point.

Optionally, performing candidate finger search based on at least the far point and the second point to obtain candidate finger information further comprises determining a first vector between the top point and the first root point; and determining a second vector between the top point and the updated candidate second root point.

Optionally, performing candidate finger search based on at least the far point and the second point to obtain candidate finger information further comprises determining a magnitude of the second vector; and determining whether the magnitude of the second vector exceeds a minimum finger length.

Optionally, performing candidate finger search based on at least the far point and the second point to obtain candidate finger information further comprises determining a cosine similarity between the first vector and the second vector; and determining whether the cosine similarity between the first vector and the second vector is greater than a maximum cosine similarity minus a second threshold value.

Optionally, performing candidate finger search based on at least the far point and the second point to obtain candidate finger information further comprises traversing a plurality of points on the contour to determine whether or not conditions for a respective point of the plurality of points being the second root point are satisfied.

Optionally, performing candidate finger search based on at least the far point and the second point to obtain candidate finger information further comprises determining a magnitude of the second vector; determining whether the magnitude of the second vector is greater than a maximum finger length; and upon determination that the magnitude of the second vector is greater than the maximum finger length, stopping traversing the plurality of points on the contour.

Optionally, performing candidate finger search based on at least the far point and the second point to obtain candidate finger information further comprises determining a cosine similarity between the first vector and the second vector; determining whether a finger has been detected; and upon determination that a finger has been detected, and the cosine similarity between the first vector and the second vector is less than the maximum cosine similarity minus the first threshold value, stopping traversing the plurality of points on the contour.

Optionally, performing candidate finger search based on at least the far point and the second point to obtain candidate finger information further comprises determining whether a finger has been detected; determining a magnitude of the second vector; determining whether the magnitude of the second vector exceeds a maximum finger width; and upon determination that a finger has not been detected, and the magnitude of the second vector exceeds the maximum finger width, stopping traversing the plurality of points on the contour.

Optionally, performing candidate finger search based on at least the far point and the second point to obtain candidate finger information further comprises determining a magnitude of the second vector; determining whether the magnitude of the second vector exceeds a minimum finger length; determining a cosine similarity between the first vector and the second vector; determining whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector.

Optionally, performing candidate finger search based on at least the far point and the second point to obtain candidate finger information further comprises determining a magnitude of the second vector; determining whether the magnitude of the second vector is greater than a maximum finger length; determining whether the magnitude of the second vector exceeds a maximum finger width; determining a cosine similarity between the first vector and the second vector; determining whether a finger has been detected; and determining whether any of the following three conditions are satisfied: the magnitude of the second vector is greater than the maximum finger length; or a finger has been detected, and the cosine similarity between the first vector and the second vector is less than the maximum cosine similarity minus the first threshold value; or a finger has not been detected, and the magnitude of the second vector exceeds the maximum finger width; wherein performing candidate finger search based on at least the far point and the second point to obtain candidate finger information further comprises, upon determination that none of the three conditions are satisfied: determining whether the magnitude of the second vector exceeds a minimum finger length; determining whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector.

Optionally, performing candidate finger search based on at least the far point and the second point to obtain candidate finger information further comprises updating a coordinate of a fingertip point; wherein updating the coordinate of the fingertip point comprises determining a line intersecting a first root point and a second root point of a candidate finger; determining a point on a contour of the candidate finger having a greatest distance from the line intersecting the first root point and the second root point; and assigning the point on the contour of the candidate finger having the greatest distance from the line intersecting the first root point and the second root point as an updated finger top point.

Optionally, performing candidate finger search based on at least the far point and the second point to obtain candidate finger information further comprises updating a coordinate of a fingerroot point; wherein updating the coordinate of the fingerroot point comprises determining a distance between the first root point and the top point of a candidate finger; determining a distance between a second root point and the top point of the candidate finger; and adjusting coordinates of at least one of the first root point and the second root point until the distance between the first root point and the top point and the distance between the second root point and the top point are substantially the same.

Optionally, performing candidate finger search based on at least the far point and the second point to obtain candidate finger information further comprises fitting a midline of a candidate finger.

Optionally, fitting the midline of the candidate finger comprises determining a line intersecting a first root point and a second root point of the candidate finger; determining a finger area using the line intersecting the first root point and the second root point of the candidate finger and a contour of the candidate finger; and fitting the midline of the finger area using an optimization algorithm.

Optionally, the computer-implemented method further comprises performing finger deduplication on detected candidate fingers; wherein performing finger deduplication on detected candidate fingers comprises calculating an intersection over union of contours of two detected candidate fingers; and upon determination that the intersection over union of the contours of the two detected candidate fingers is greater than a threshold value, determining that the two detected candidate fingers are duplicates of a same candidate finger.

Optionally, calculating an intersection over union of contours of two detected candidate fingers comprises determining a first contour of a first detected candidate finger of the two detected candidate fingers including a first candidate root point, a second candidate root point, and a first candidate top point; determining a second contour of a second detected candidate finger of the two detected candidate fingers including a third candidate root point, a fourth candidate root point, and a second candidate top point; determining a first length of the first contour; determining a second length of the second contour; determining a third length of an intersection between the first contour and the second contour; and calculating the intersection over union of contours of two detected candidate fingers by

$$\frac{the third length}{min ( the first length , the second length )} .$$

Optionally, the computer-implemented method further comprises performing a filtering process to remove false detection among detected fingers; wherein performing a filtering process to remove false detection among detected fingers comprises at least one of: determining a candidate finger length by determining a distance between a candidate top point and a candidate root point; determining a candidate finger width by determining a distance between two candidate root points; or determining an aspect ratio of the candidate finger by dividing the candidate finger length by the candidate finger width.

Optionally, performing a filtering process to remove false detection among detected fingers further comprises at least one of: assigning the candidate finger as a falsely detected finger upon determination that the candidate finger length is less than a minimum finger length; assigning the candidate finger as a falsely detected finger upon determination that the candidate finger width is greater than a maximum finger width; or assigning the candidate finger as a falsely detected finger upon determination that the aspect ratio of the candidate finger is less than a minimum aspect ratio.

In another aspect, the present disclosure provides an apparatus for detecting fingertip in an image, comprising a memory; and one or more processors; wherein the memory and the one or more processors are connected with each other; and the memory stores computer-executable instructions for controlling the one or more processors to obtain a contour of a hand in the image; and perform finger detection on the contour to obtain finger position information; wherein, to perform finger detection, the memory stores computer-executable instructions for controlling the one or more processors to perform a convex hull detection; perform a convex hull defect detection to obtain at least one convex hull defect, wherein a respective convex hull defect of the at least one convex hull defect comprises a far point, a first point, and a second point, the far point, the first point, and the second point being points on the contour; and perform candidate finger search based on at least the far point and the second point to obtain the finger position information.

In another aspect, the present disclosure provides a computer-program product, comprising a non-transitory tangible computer-readable medium having computer-readable instructions thereon, the computer-readable instructions being executable by a processor to cause the processor to perform obtaining a contour of a hand in the image; and performing finger detection on the contour to obtain finger position information; wherein performing finger detection comprises performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; and performing candidate finger search based on at least the far point and the second point to obtain the finger position information.

In another aspect, the present disclosure provides a computer-implemented method of searching finger in an image, comprising obtaining a contour of a hand in the image; and performing finger detection on the contour to obtain finger position information; wherein performing finger detection comprises performing a convex hull detection; performing a convex hull defect detection to obtain at least one convex hull defect, wherein a respective convex hull defect of the at least one convex hull defect comprises a far point and a second point, the far point and the second point being points on the contour; and performing finger search based on at least the far point and the second point.

In another aspect, the present disclosure provides a computer-implemented method of detecting fingertip in an image, comprising obtaining a contour of a hand in the image; and performing finger detection on the contour to obtain finger position information; wherein performing finger detection comprises performing a convex hull detection; performing a convex hull defect detection to obtain at least one convex hull defect, wherein a respective convex hull defect of the at least one convex hull defect comprises a far point and a second point, the far point and the second point being points on the contour; and obtaining the finger position information based on at least the far point and the second.

### BRIEF DESCRIPTION OF THE FIGURES

The following drawings are merely examples for illustrative purposes according to various disclosed embodiments and are not intended to limit the scope of the present invention.

FIG. 1A is a flow chart illustrating a computer-implemented method of detecting fingertip in an image in some embodiments according to the present disclosure.

FIG. 1B is a flow chart illustrating a computer-implemented method of detecting fingertip in an image in some embodiments according to the present disclosure.

FIG. 2 shows a binary hand region after image segmentation in some embodiments according to the present disclosure.

FIG. 3 shows a contour of a hand determined in an image in some embodiments according to the present disclosure.

FIG. 4 shows a convex hull determined in a process of identifying candidate regions that represent fingers in a contour of a hand in some embodiments according to the present disclosure.

FIG. 5 shows a convex hull defect detected in a convex hull in some embodiments according to the present disclosure.

FIG. 6 illustrates a process of detecting fingertip in an image in some embodiments according to the present disclosure.

FIG. 7A is a flow chart illustrating a computer-implemented method of detecting fingertip in an image in some embodiments according to the present disclosure.

FIG. 7B is a flow chart illustrating a computer-implemented method of detecting fingertip in an image in some embodiments according to the present disclosure.

FIG. 8 shows a candidate finger being considered in a fingertip detection process in some embodiments according to the present disclosure.

FIG. 9 shows a candidate finger with an updated candidate second root point being considered in a fingertip detection process in some embodiments according to the present disclosure.

FIG. 10 shows an updated second root point being considered in a fingertip detection process in some embodiments according to the present disclosure.

FIG. 11 shows a midline fitting in a fingertip detection process in some embodiments according to the present disclosure.

FIG. 12 is a schematic diagram illustrating an apparatus for detecting fingertip in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a computer-implemented method of detecting fingertip in an image, an apparatus for detecting fingertip in an image, and a computer-program product that substantially obviate one or more of the problems due to limitations and disadvantages of the related art. In one aspect, the present disclosure provides a computer-implemented method of detecting fingertip in an image. In some embodiments, the computer-implemented method includes obtaining a contour of a hand in the image; and performing finger detection on the contour to obtain finger position information. Optionally, performing finger detection includes performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information.

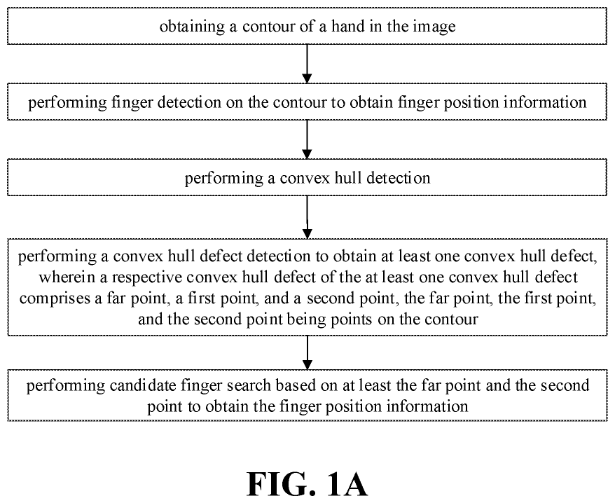

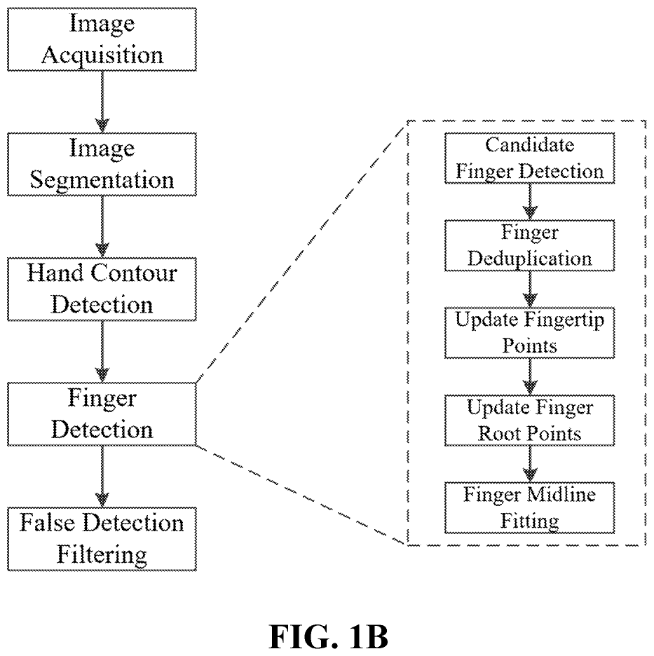

FIG. 1A is a flow chart illustrating a computer-implemented method of detecting fingertip in an image in some embodiments according to the present disclosure. Referring to FIG. 1A, in some embodiments, the computer-implemented method includes obtaining a contour of a hand in the image; and performing finger detection on the contour to obtain finger position information. Optionally, performing finger detection includes performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information. Examples of finger position information include finger tip position information, finger root position information, finger orientation information, finger spread information, and finger curl information. Finger tip information may include coordinates of finger tips. Finger root information may include coordinates of one or more points in a region where each finger is connected to a palm. Finger orientation information may include an angle of each finger relative to a reference direction. Finger spread information may include information about the separation or distance between finger tips. Finger curl information may include information about the degree to which a finger is bent or curved.

In some embodiments, the far point, the first point, and the second point are points on an edge of a respective convex hull defect. In some embodiments, the first point and the second point are also points on a convex hull detected according to the present disclosure; however, the far point is not a point on the convex hull. The far point, the first point, and the second point are vertex points of a polygon shape of the convex hull defect. In some embodiments, the far point, the first point, and the second point are sequentially arranged along the edge of the convex hull defect. In one example, the far point, the first point, and the second point are sequentially arranged along a clockwise direction along the edge of the convex hull defect. In another example, the far point, the first point, and the second point are sequentially arranged along a counter-clockwise direction along the edge of the convex hull defect.

FIG. 1B is a flow chart illustrating a computer-implemented method of detecting fingertip in an image in some embodiments according to the present disclosure. Referring to FIG. 1B, the computer-implemented method of detecting fingertip in an image in some embodiments includes acquiring an image (“Image Acquisition”); segmenting the image (“Image Segmentation”); determining a contour of a hand in the image (“Hang Contour Detection”); performing finger detection on the contour of the hand (“Finger Detection”); and performing a filtering process to remove false detection among detected fingers (“False Detection Filtering”). Optionally, acquiring the image includes capturing the image using an image acquisition device such as a camera (e.g., a depth camera).

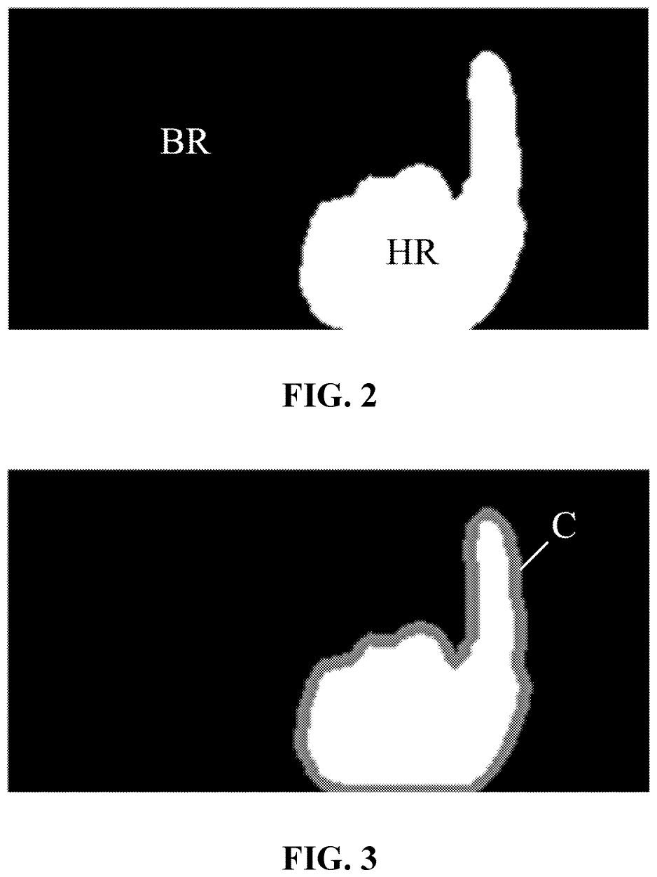

In some embodiments, segmenting the image includes dividing the image into multiple non-overlapping regions (e.g., at the pixel level). Various appropriate image segmentation techniques may be used for segmenting the image. Examples of appropriate image segmentation techniques include thresholding, region growing, or deep learning-based segmentation models like U-Net and Mask R-CNN. FIG. 2 shows a binary image after image segmentation in some embodiments according to the present disclosure. Referring to FIG. 2, the image is divided into multiple non-overlapping regions including a hand region HR and a background region BR. In one example, pixels representing the hand region HR have a grayscale value of 255, while pixel representing the background region BR have a grayscale value of 0.

In some embodiments, determining the contour of the hand in the image includes determining a region comprising the hand in one or more of the multiple non-overlapping regions. Various appropriate contour detection algorithms may be used for determining the contour of the hand in the image. Examples of appropriate contour detection algorithms include edge detection and edge tracing. Optionally, determining the contour of the hand in the image further includes performing a preliminary selection based on features such as hand shape, relative position, and so on. In one example, the preliminary selection is performed based on heuristic rules. FIG. 3 shows a contour of a hand determined in an image in some embodiments according to the present disclosure. Referring to FIG. 2 and FIG. 3, a contour C of the hand is determined in the image. The contour C surrounds a region comprising the hand in the hand region HR. Optionally, the contour C includes a plurality of contour points. Optionally, the contour C further includes one or more contour lines.

In some embodiments, performing finger detection on the contour of the hand is based on morphological features of fingers or other shape descriptors. Examples of morphological features of fingers include a length of a finger and a width of a finger.

In some embodiments, performing the filtering process to remove false detection among detected fingers is based on heuristic rules and context information such as finger relationships and finger-palm relationship. The heuristic rules are developed based on the understanding of typical finger and hand configurations, considering the natural constraints and anatomical characteristics of the human hand. By leveraging these heuristic rules, the filtering process aims to improve the accuracy and reliability of the detected fingers. The contextual information, including finger relationships and finger-palm relationship, is taken into account during the filtering process. For example, the relative positions and orientations of neighboring fingers can be considered to identify and remove false detections that do not align with the expected finger configuration. Similarly, the relationship between the fingers and the palm can be analyzed to distinguish between genuine fingers and potential false detections caused by the palm or other hand regions. The inventors of the present disclosure discover that, by incorporating heuristic rules and context information such as finger relationships and finger-palm relationship, the filtering process enhances the precision of the finger detection results. It helps to refine the detected finger locations, remove false detections, and ensure that the final output represents the actual fingers present in the hand region accurately.

In some embodiments, as shown in FIG. 1B, performing finger detection on the contour of the hand includes identifying candidate regions that represent fingers in the contour of the hand (“Candidate Finger Detection”); performing finger deduplication on detected candidate fingers (“Finger Deduplication”); updating coordinates of fingertip points based on shape and position information of the detected candidate fingers (“Update Fingertip Points”); updating coordinates of finger root points based on the shape and position information of the detected candidate fingers (“Update Finger Root Points”); and fitting a midline of a candidate finger (“Finger Midline Fitting”).

In some embodiments, identifying candidate regions that represent fingers in the contour of the hand is based on heuristic rules or a feature extraction process. In one example, the feature extraction process is performed to extract features such as finger shape, finger length, and finger width.

In some embodiments, performing finger deduplication on detected candidate fingers includes comparing distances and overlap between the detected candidate fingers to merge or remove duplicate detections, ensuring that each finger is detected only once.

In some embodiments, updating coordinates of fingertip points based on shape and position information of the detected candidate fingers is based on shape and position information of the detected candidate fingers. The location of the fingertip points can be determined using heuristic rules or feature analysis, such as the tip or the point of maximum curvature of the finger.

In some embodiments, updating coordinates of finger root points based on the shape and position information of the detected candidate fingers is based on the shape and position information of the detected candidate fingers. The position of the finger root points can be determined using heuristic rules or feature analysis, such as the base of the finger or points with lower curvature.

In some embodiments, fitting the midline of the finger includes connecting the fingertip points and finger root points. Various appropriate fitting algorithms may be used for fitting the midline of the finger. Examples of appropriate fitting algorithms includes least squares and curve fitting.

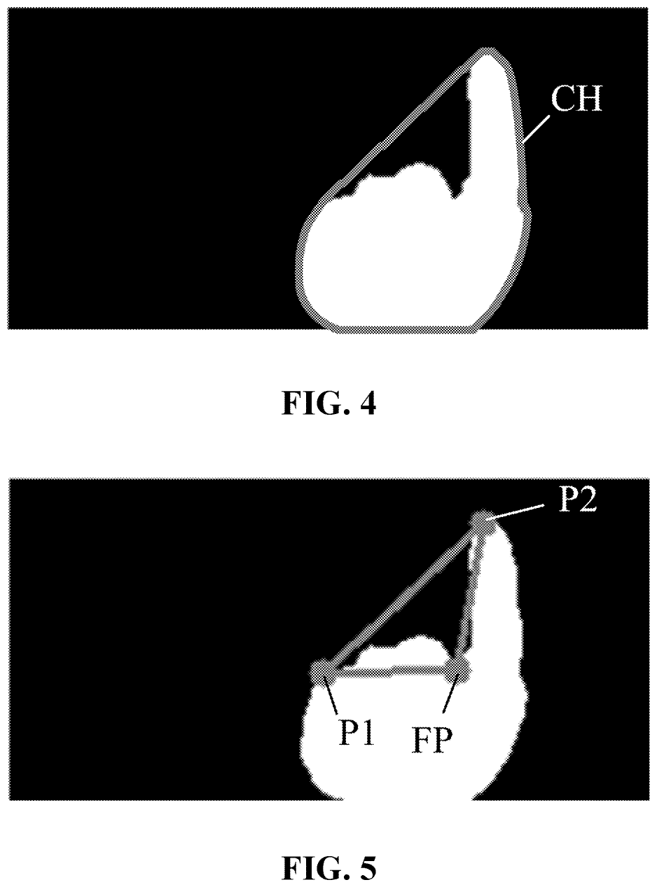

Various appropriate algorithms may be used for identifying candidate regions that represent fingers in the contour of the hand. In some embodiments, identifying candidate regions that represent fingers in the contour of the hand is performed using a convex hull algorithm, e.g., a convex hull algorithm in OpenCV. Convex hull algorithm is an algorithm used to identify the convex hull of a region, which represents the outer boundary enclosing the given set of points. In one example, the convex hull algorithm is employed to identify the hand's outer boundary. FIG. 4 shows a convex hull determined in a process of identifying candidate regions that represent fingers in a contour of a hand in some embodiments according to the present disclosure. Referring to FIG. 4, a convex hull CH is denoted. As used herein, the term “convex hull” refers to a smallest convex polygon that encompasses a set of points in a Euclidean space. In one example, the convex hull is a shape obtained when an elastic band is wrapped around a set of points, and it stretches to form the smallest convex boundary that encloses all of the points in the set of points.

In some embodiments, identifying candidate regions that represent fingers in the contour of the hand further includes performing a convex hull defect detection. Various appropriate convex hull defect detection algorithms may be used in the present disclosure to detect one or more convex hull defects in the convex hull. As used herein, the term “convex hull defect” refers to irregularities or anomalies in the shape of a convex hull. The convex hull is a polygon that encloses a set of points while maintaining a convex (outward-curved) shape. When performing defect detection within this context, one is looking for areas where the actual shape deviates from its expected smooth, convex shape. These deviations or irregularities could be indications of defects or anomalies within the dataset or object being analyzed. FIG. 5 shows a convex hull defect detected in a convex hull in some embodiments according to the present disclosure. Referring to FIG. 5, the convex hull defect is represented by a triangle having three vertexes including a far point FP, a first point P1, and a second point P2. The far point FP is a point in a concave region of the convex hull that is farthest. The far point FP represents the depth of the concavity, or the extent to which it deviates from the convex hull. The far point FP is essential for detecting and describing the shape and properties of the convex hull defect. The first point P1 and the second point P2 specify the starting and ending points of the convex hull defect. The first point P1 and the second point P2 are typically used to locate and describe the position and boundaries of the convex hull defect.

In some embodiments, the computer-implemented method includes obtaining a contour of a hand in the image; and performing finger detection on the contour to obtain finger position information. In some embodiments, performing finger detection includes performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information.

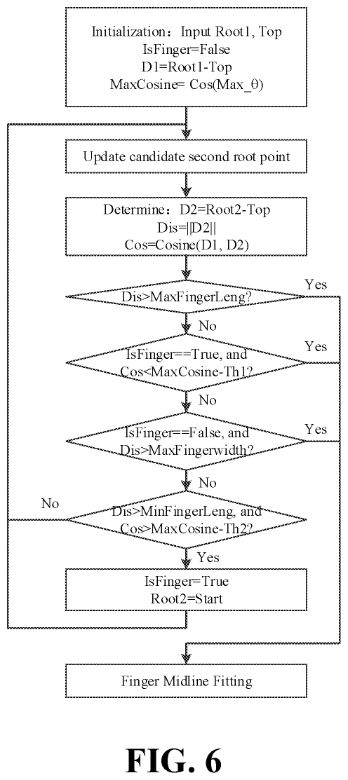

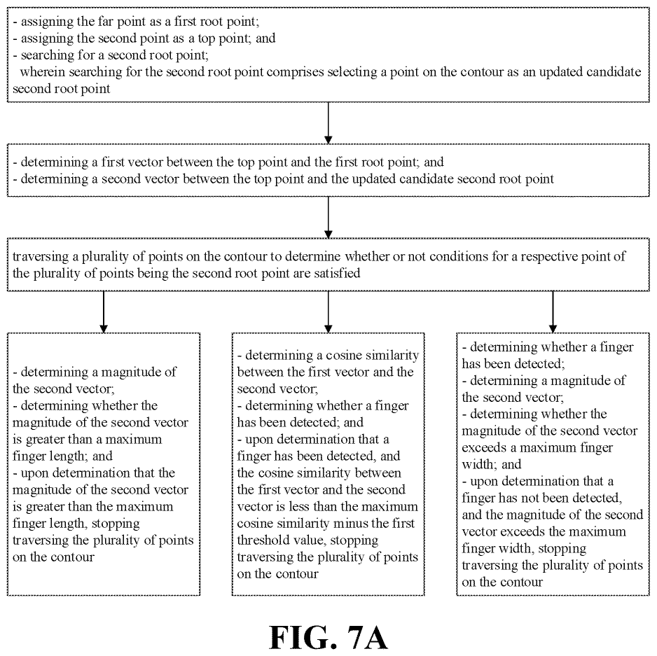

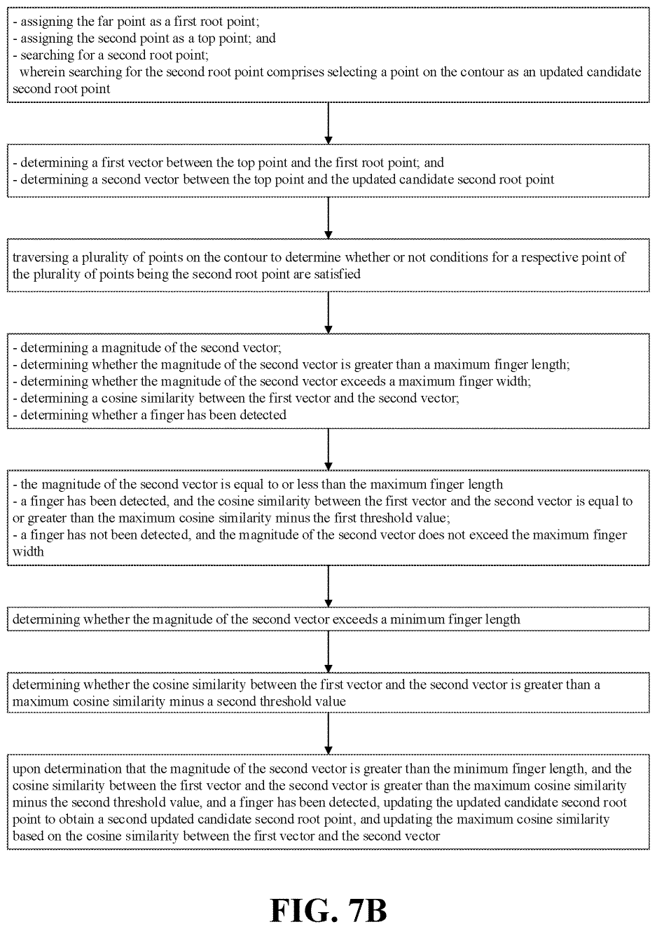

FIG. 6 illustrates a process of detecting fingertip in an image in some embodiments according to the present disclosure. FIG. 7A is a flow chart illustrating a computer-implemented method of detecting fingertip in an image in some embodiments according to the present disclosure. FIG. 7B is a flow chart illustrating a computer-implemented method of detecting fingertip in an image in some embodiments according to the present disclosure. Referring to FIG. 6, FIG. 7A, and FIG. 7B, the computer-implemented method in some embodiments includes receiving coordinates of a first root point (“Root1”) and a top point (“Top”). The root point refers to a specific point on a hand where a finger begins or originates. The root point is typically located at the base of the finger, closest to the hand or palm. The root point serves as a reference for tracking and analyzing the finger's movement and shape. The top point refers to a highest or uppermost point of the finger. The top point represents the tip or endpoint of the finger. The top point is crucial for determining finger length, curvature, and orientation. The one or more end points refer to one or multiple points around the fingertip region.

In some embodiments, the first root point may be a far point detected in a convex hull defect detection process, and the top point may be a second point detected in the convex hull defect detection process. In some embodiments, performing candidate finger search based on at least the far point and the second point to obtain candidate finger information includes assigning the far point as a first root point; assigning the second point as a top point; and searching for a second root point. In some embodiments, searching for the second root point includes selecting a point on the contour as an updated candidate second root point.

In some embodiments, the computer-implemented method further includes determining whether a finger has been detected (“IsFinger-False”); and upon determination that a finger has not been detected, the computer-implemented method further includes performing finger detection on the contour to obtain finger position information.

In some embodiments, performing finger detection on the contour to obtain finger position information includes assigning the far point as a first root point; assigning the second point as a top point; and searching for a second root point. In some embodiments, searching for the second root point comprises selecting a point on the contour as an updated candidate second root point.

Referring to FIG. 6, FIG. 7A, and FIG. 7B, in some embodiments, performing finger detection on the contour to obtain finger position information further includes determining a first vector between the top point and the first root point (“D1=Root1−Top”). Optionally, the first vector is determined by subtracting a coordinate of the top point from a coordinate of the first root point, or by subtracting the coordinate of the first root point from the coordinate of the top point.

Referring to FIG. 6, FIG. 7A, and FIG. 7B, in some embodiments, performing finger detection on the contour to obtain finger position information further includes determining a second vector between the top point and the updated candidate second root point. Optionally, the second vector is determined by subtracting the coordinate of the top point from a coordinate of a candidate second root point, or by subtracting the coordinate of the candidate second root point from the coordinate of the top point.

In some embodiments, performing finger detection on the contour to obtain finger position information further includes setting a maximum cosine similarity to an initial value (e.g., Cos(Max_θ). As the finger detection algorithm progresses and analyzes different points around the fingertip, a cosine similarity between the first vector and the second vector is calculated for each point. The calculated cosine similarity is compared to a current value of the maximum cosine similarity. The maximum cosine similarity represents the closest match or similarity between the direction of the first vector and the direction of the second vector with respect to each end point around the fingertip detected during the process. The purpose of storing the maximum cosine similarity is to track the most similar direction to the direction of the first vector (e.g., the finger's direction) among the end points analyzed. It can be used as a criterion for determining whether a particular point is a candidate for being part of the finger or not (e.g., whether a candidate second root point is indeed a second root point).

Various appropriate initial values may be used as the initial value of the maximum cosine similarity. In one particular example, the Max_θ is 45 degrees, and the initial value of the maximum cosine similarity is

$$\frac{\sqrt{2}}{2} .$$

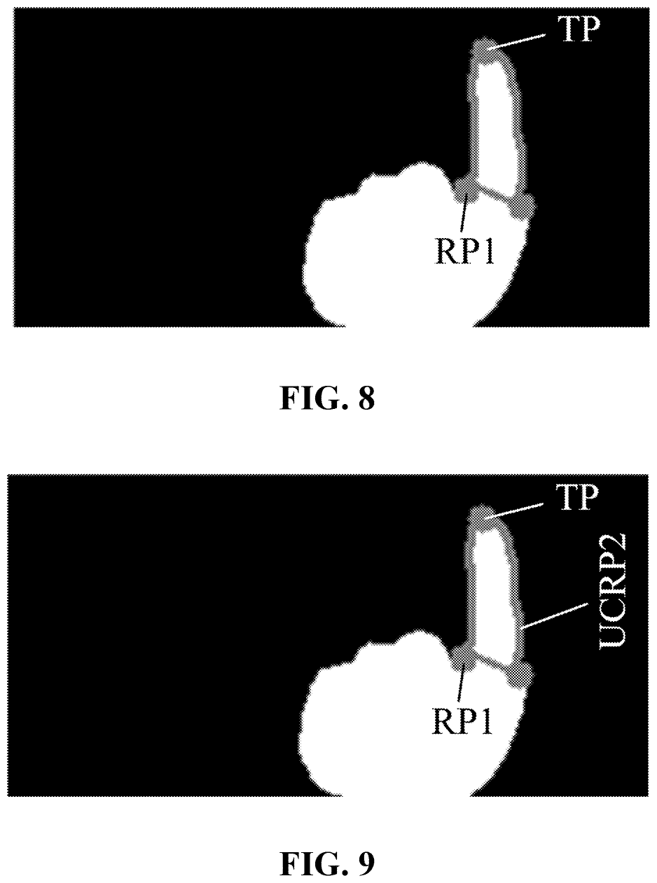

In some embodiments, performing finger detection on the contour to obtain finger position information further includes extracting coordinates of the first root point and the top point. In some embodiments, the computer-implemented method includes performing a pre-processing process on the image to extract coordinates of one or more fingertips, a palm, and/or other hand features; and determining the coordinates of the first root point and the top point based on the coordinates of the one or more fingertips, a palm, and/or other hand features. FIG. 8 shows a candidate finger being considered in a fingertip detection process in some embodiments according to the present disclosure. Referring to FIG. 8, a top point TP and a first root point RP1 are identified in the candidate finger.

Referring to FIG. 6, FIG. 7A, and FIG. 7B, in some embodiments, performing finger detection on the contour to obtain finger position information further includes updating candidate second root point to obtain an updated candidate second root point. FIG. 9 shows a candidate finger with an updated candidate second root point being considered in a fingertip detection process in some embodiments according to the present disclosure. Referring to FIG. 9, an updated candidate second root point UCRP2 is identified in the candidate finger.

In some embodiments, performing finger detection on the contour to obtain finger position information further includes determining a magnitude of the second vector. Optionally, the magnitude of the second vector is expressed as Dis=∥D2∥, wherein the double vertical bars (∥ ∥) denote a Euclidean norm of the second vector, representing a distance between the top point and the updated candidate second root point.

In some embodiments, performing finger detection on the contour to obtain finger position information further includes determining a cosine similarity between the first vector and the second vector. The cosine similarity between the first vector and the second vector measures the cosine of the angle between the first vector and the second vector, providing an indication of their similarity. Optionally, the cosine similarity between the first vector and the second vector equals to a dot product of the first vector and the second vector divided by a product of a magnitude of the first vector and a magnitude of second third vector. In some embodiments, the cosine similarity between the first vector and the second vector is

$$Cos ( θ ) = \frac{〈 D 1 , D 2 〉}{‖ D 1 ‖ \cdot ‖ D 2 ‖} ,$$

wherein D1 stands for the first vector, and D2 stand for the second vector.

Referring to FIG. 6, FIG. 7A, and FIG. 7B, in some embodiments, performing finger detection on the contour to obtain finger position information further includes traversing a plurality of points on the contour to determine whether or not conditions for a respective point of the plurality of points being the second root point are satisfied.

In some embodiments, traversing the plurality of points includes traversing a plurality of points on the contour of the hand in the image in a clockwise manner. In some embodiments, when the far point, the first point, and the second point are sequentially arranged along a clockwise direction along the edge of the convex hull defect, the plurality of points on the contour of the hand in the image are traversed in a clockwise manner.

In alternative embodiments, traversing the plurality of points includes traversing a plurality of points on the contour of the hand in the image in a counter-clockwise manner. In some embodiments, when the far point, the first point, and the second point are sequentially arranged along a counter-clockwise direction along the edge of the convex hull defect, the plurality of points on the contour of the hand in the image are traversed in a counter-clockwise manner.

In some embodiments, adjacent points of the plurality of points on the contour of the hand in the image are spaced apart by at least one point on the contour of the hand in the image. In one example, the adjacent points of the plurality of points on the contour of the hand in the image are spaced apart by X numbers of points, e.g., by 50 points, by 75 points, by 100 points, or by 125 points.

Referring to FIG. 6, FIG. 7A, and FIG. 7B, in some embodiments, performing finger detection on the contour to obtain finger position information further includes determining a magnitude of the second vector; determining whether the magnitude of the second vector is greater than a maximum finger length (“Dis>MaxFingerLeng?”); and upon determination that the magnitude of the second vector is greater than the maximum finger length, stopping traversing the plurality of points on the contour. The purpose of this condition is to determine if the magnitude of the second vector (representing a distance between the top point and the updated candidate second root point) exceeds the maximum allowable finger length. If the magnitude of the second vector is greater than the maximum finger length, it indicates that the distance between the top point and the updated candidate second root point exceeds the maximum limit. In such a case, it may not align with the expected characteristics of a finger, and thus, it would be considered as a non-finger. This condition helps filter out update candidate second root points that are too far away, allowing for more accurate identification and detection of fingers. In one example, the maximum finger length is a length in the image that corresponds to a length of 70 mm of an actual finger. In another example, the maximum finger length is a length in the image that corresponds to a length of 75 mm of an actual finger. In another example, the maximum finger length is a length in the image that corresponds to a length of 80 mm of an actual finger. In another example, the maximum finger length is a length in the image that corresponds to a length of 85 mm of an actual finger. In another example, the maximum finger length is a length in the image that corresponds to a length of 90 mm of an actual finger. In another example, the maximum finger length is a length in the image that corresponds to a length of 95 mm of an actual finger. In another example, the maximum finger length is a length in the image that corresponds to a length of 100 mm of an actual finger.

Referring to FIG. 6, FIG. 7A, and FIG. 7B, in some embodiments, performing finger detection on the contour to obtain finger position information further includes determining a cosine similarity between the first vector and the second vector; determining whether a finger has been detected (“IsFinger==True?”); and upon determination that a finger has been detected, and the cosine similarity between the first vector and the second vector is less than the maximum cosine similarity minus the first threshold value (“Cos<MaxCosine−Th1”), stopping traversing the plurality of points on the contour. If a finger has been detected, and the cosine similarity between the first vector and the second vector is less than the maximum cosine similarity minus the first threshold value, it indicates that the similarity between the direction of the first vector and the direction of the second vector is not as good as the highest cosine similarity value (the maximum cosine similarity). The condition that a finger has been detected, and the cosine similarity between the first vector and the second vector is less than the maximum cosine similarity minus the first threshold value, implies that the updated candidate second root point is not the best candidate for the second root point. Optionally, the first threshold value is in a range of 0.05 to 0.35, e.g., 0.05 to 0.35, e.g., 0.05 to 0.1, 0.1 to 0.15, 0.15 to 0.2, 0.25 to 0.3, or 0.3 to 0.35. The first threshold value provides a margin in comparing the cosine similarity between the first vector and the second vector with the maximum cosine similarity.

Referring to FIG. 6, FIG. 7A, and FIG. 7B, in some embodiments, performing finger detection on the contour to obtain finger position information further includes determining whether a finger has been detected; determining a magnitude of the second vector; determining whether the magnitude of the second vector exceeds a maximum finger width; and upon determination that a finger has not been detected (“IsFinger==False”), and the magnitude of the second vector exceeds the maximum finger width (“Dis>MaxFingerwidth”), stopping traversing the plurality of points on the contour. If a finger has not been detected in the finger detection process so far, and the magnitude of the second vector exceeds a maximum finger width, it indicates that a finger is unlikely to be detected using the points identified so far (e.g., the top point, the first root point, and the updated candidate second root). This condition helps in filtering out false detections or points that do not align with the typical shape or characteristics of a finger. The method may continue candidate finger search based on a different convex hull defect.

Referring to FIG. 6, FIG. 7A, and FIG. 7B, in some embodiments, performing finger detection on the contour to obtain finger position information further includes determining a magnitude of the second vector; determining whether the magnitude of the second vector exceeds a minimum finger length; determining a cosine similarity between the first vector and the second vector; determining whether the cosine similarity between the first vector and the second vector is greater than a maximum cosine similarity minus a second threshold value; and upon determination that the magnitude of the second vector is greater than the minimum finger length (“Dis>MinFingerLeng”), and the cosine similarity between the first vector and the second vector is greater than the maximum cosine similarity minus the second threshold value (“Cos>MaxCosine-Th2”), updating the updated candidate second root point to obtain a second updated candidate second root point, and updating the maximum cosine similarity based on the cosine similarity between the first vector and the second vector (e.g., assigning the cosine similarity between the first vector and the second vector as the maximum cosine similarity). Optionally, the second threshold value is in a range of 0.05 to 0.35, e.g., 0.05 to 0.1, 0.1 to 0.15, 0.15 to 0.2, 0.25 to 0.3, or 0.3 to 0.35.

If the first condition (whether the magnitude of the second vector exceeds a minimum finger length) is met, it suggests that the distance between the top point and the updated candidate second root point meets the minimum finger length requirement. In one example, the minimum finger length is a length in the image that corresponds to a length of 65 mm of an actual finger. In another example, the minimum finger length is a length in the image that corresponds to a length of 60 mm of an actual finger. In another example, the minimum finger length is a length in the image that corresponds to a length of 55 mm of an actual finger. In another example, the minimum finger length is a length in the image that corresponds to a length of 50 mm of an actual finger. In another example, the minimum finger length is a length in the image that corresponds to a length of 45 mm of an actual finger. In another example, the minimum finger length is a length in the image that corresponds to a length of 40 mm of an actual finger. In another example, the minimum finger length is a length in the image that corresponds to a length of 35 mm of an actual finger.

The second condition (whether the cosine similarity between the first vector and the second vector is greater than the maximum cosine similarity minus a second threshold value) checks if the similarity between the first vector and the second vector is significant enough to surpass the second threshold.

When both the first condition and the second condition are met, it indicates that the updated candidate second root point is likely to be the best candidate for the second root point of the finger. These conditions help filter out points that do not meet the length or direction criteria for being considered the best candidate for the second root point of the finger.

In some embodiments, upon determination that the magnitude of the second vector is not greater than the minimum finger length, or the cosine similarity between the first vector and the second vector is not greater than the maximum cosine similarity minus a second threshold value, performing finger detection on the contour to obtain finger position information further includes updating the updated candidate second root point to obtain a second updated candidate second root point. The subsequent relevant processes depicted in FIG. 6, FIG. 7A, and FIG. 7B are reiterated.

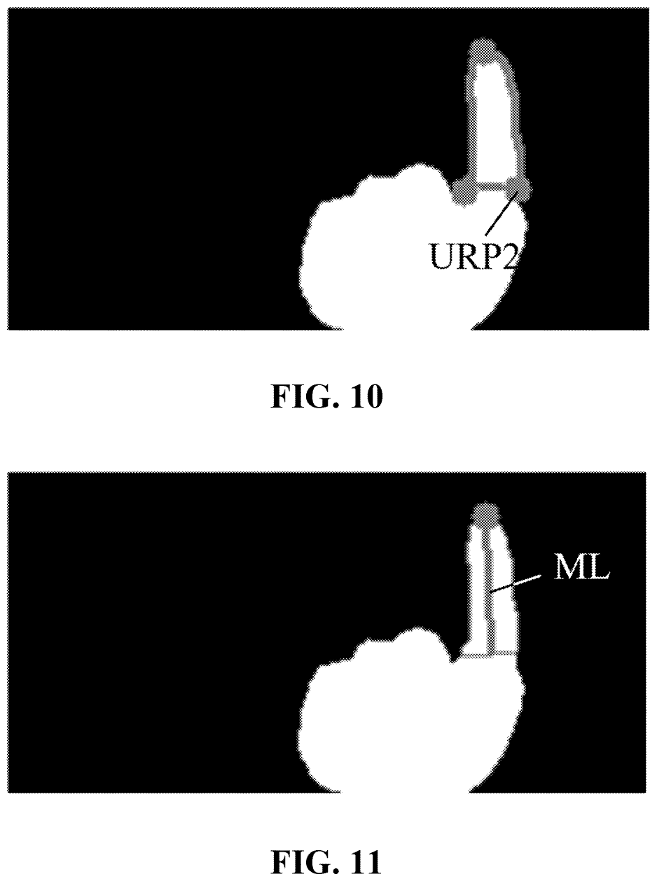

In some embodiments, upon determination that the magnitude of the second vector exceeds the minimum finger length, and the cosine similarity between the first vector and the second vector is greater than the maximum cosine similarity minus a second threshold value, performing finger detection on the contour to obtain finger position information further includes determining whether a finger has been detected. Upon determination that a finger has been detected, performing finger detection on the contour to obtain finger position information further includes assigning the updated candidate second root point as an updated second root point. Subsequently, the computer-implemented method further includes updating the updated candidate second root point to obtain a third updated candidate second root point. The subsequent relevant processes depicted in FIG. 6, FIG. 7A, and FIG. 7B are reiterated. FIG. 10 shows an updated second root point being considered in a fingertip detection process in some embodiments according to the present disclosure. Referring to FIG. 10, an updated second root point URP2 is assigned in the candidate finger.

Referring to FIG. 6, FIG. 7A, and FIG. 7B, in some embodiments, performing finger detection on the contour to obtain finger position information further includes determining a magnitude of the second vector; determining whether the magnitude of the second vector is greater than a maximum finger length; determining whether the magnitude of the second vector exceeds a maximum finger width; determining a cosine similarity between the first vector and the second vector; determining whether a finger has been detected; and determining whether any of the following three conditions are satisfied: the magnitude of the second vector is greater than the maximum finger length; or a finger has been detected, and the cosine similarity between the first vector and the second vector is less than the maximum cosine similarity minus the first threshold value; or a finger has not been detected, and the magnitude of the second vector exceeds the maximum finger width. In some embodiments, performing candidate finger search based on at least the far point and the second point to obtain candidate finger information further includes, upon determination that none of the three conditions are satisfied, determining whether the magnitude of the second vector exceeds a minimum finger length; determining whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector (e.g., assigning the cosine similarity between the first vector and the second vector as the maximum cosine similarity).

FIG. 11 shows a midline fitting in a fingertip detection process in some embodiments according to the present disclosure. Referring to FIG. 11, a midline ML of the finger is determined in the fingertip detection process. The midline fitting is a process in a fingertip detection process where an optimal central line of a finger is identified. Optionally, the computer-implemented method further includes optimize the midline, e.g., by adjusting parameters of the midline, thereby minimizing the distance between the midline and the contour of the finger and ensuring the midline accurately represents a central axis of the finger.

In some embodiments, finger deduplication is performed to detect duplicate candidate fingers. For example, the convex hull detection according to the present disclosure may result in detection of a plurality of convex hull defects. Candidate finger search may be performed on each of the plurality of convex hull defects, thereby detecting a plurality of detected candidate fingers. In one example, two of the plurality of detected candidate fingers are duplicates.

In some embodiments, performing finger deduplication on detected candidate fingers includes calculating an intersection over union (IOU) of contours of two detected candidate fingers; and, upon determination that the intersection over union of the contours of the two detected candidate fingers is greater than a threshold value, determining that the two detected candidate fingers are duplicates of a same candidate finger. Optionally, the computer-implemented method further includes determining finger lengths of the two detected candidate fingers, and deleting one of the two detected candidate fingers having a smaller finger length.

In some embodiments, a first contour of a first detected candidate finger of the two detected candidate fingers includes a first candidate root point, a second candidate root point, and a first candidate top point; a second contour of a second detected candidate finger of the two detected candidate fingers includes a third candidate root point, a fourth candidate root point, and a second candidate top point. Optionally, the first contour has a first length, the second contour has a second length. Optionally, an intersection between the first contour and the second contour has a third length. Optionally, an intersection over union of the first contour and the second contour is

$$\frac{the third length}{min ( the first length , the second length )} .$$

In some embodiments, updating coordinates of fingertip points based on shape and position information of the detected candidate fingers includes determining a line intersecting a first root point and a second root point of a candidate finger; determining a point on a contour of the candidate finger having a greatest distance from the line intersecting the first root point and the second root point; and assigning the point on the contour of the candidate finger having the greatest distance from the line intersecting the first root point and the second root point as an updated finger top point. As used herein, in the step of updating coordinates of fingertip points, the “first root point” may be a far point detected during a convex hull defect detection, or may be an updated first root point updated during the candidate finger search. As used herein, in the step of updating coordinates of fingertip points, the “second root point” may be a second root point determined according to a step in the present method, or an updated second root point updated during the candidate finger search.

In some embodiments, updating coordinates of finger root points based on the shape and position information of the detected candidate fingers includes determining a distance between a first root point and a top point of a candidate finger; determining a distance between a second root point and the top point of the candidate finger; and adjusting coordinates of at least one of the first root point and the second root point until the distance between the first root point and the top point and the distance between the second root point and the top point are substantially the same. As used herein, in the step of updating the coordinate of the fingerroot point, the “top point” may be a second point detected during a convex hull defect detection, or may be the updated finger top point described above. As used herein, the term “substantially the same” refers to a difference between two values not exceeding 10% of a base value (e.g., one of the two values), e.g., not exceeding 8%, not exceeding 6%, not exceeding 4%, not exceeding 2%, not exceeding 1%, not exceeding 0.5%, not exceeding 0.1%, not exceeding 0.05%, and not exceeding 0.01%, of the base value.

In some embodiments, fitting a midline of the candidate finger includes determining a line intersecting a first root point and a second root point of a candidate finger; determining a finger area using the line intersecting the first root point and the second root point of the candidate finger and a contour of the candidate finger; and fitting the midline of the finger area using an optimization algorithm. As used herein, in the step of updating coordinates of fingertip points, the “first root point” may be a far point detected during a convex hull defect detection, or may be an updated first root point updated during the candidate finger search. As used herein, in the step of updating coordinates of fingertip points, the “second root point” may be a second root point determined according to a step in the present method, or an updated second root point updated during the candidate finger search. Examples of optimization algorithms include least square algorithm and gradient descent algorithm. In some embodiments, the midline of the candidate finger is expressed as:

$$Middle\_Line = {min}_{Line} \frac{{\sum }_{( x , y ) ∈ FingerArea} Distance ( ( x , y ) , Line )}{N ( FingerArea )} ;$$

wherein Distance ((x, y), Line) stands for a distance between a point (x, y) to the midline; N(FingerArea) stands for a number of points in the finger area. Optionally, the midline intersects with the contour of the candidate finger at a fingertip point and a fingerroot point.

In some embodiments, perform a filtering process to remove false detection among detected fingers includes at least one of determining a candidate finger length by determining a distance between a candidate top point and a candidate root point; determining a candidate finger width by determining a distance between two candidate root points; or determining an aspect ratio of the candidate finger by dividing the candidate finger length by the candidate finger width. Optionally, the computer-implemented method further includes assigning the candidate finger as a falsely detected finger upon determination that the candidate finger length is less than a minimum finger length. Optionally, the computer-implemented method further includes assigning the candidate finger as a falsely detected finger upon determination that the candidate finger width is greater than a maximum finger width. Optionally, the computer-implemented method further includes assigning the candidate finger as a falsely detected finger upon determination that the aspect ratio of the candidate finger is less than a minimum aspect ratio.

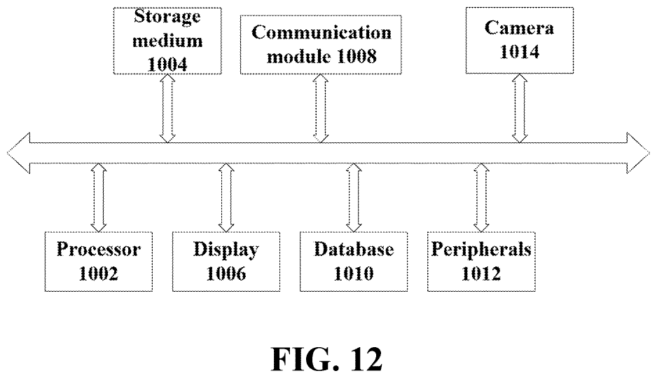

In another aspect, the present disclosure provides an apparatus for detecting fingertip in an image. FIG. 12 is a schematic diagram illustrating an apparatus for detecting fingertip in some embodiments according to the present disclosure. Referring to FIG. 12, the apparatus in some embodiments includes a processor 1002, a storage medium 1004, a display 1006, a communication module 1008, a database 1010, peripherals 1012, and a camera 1014. Certain devices may be omitted, and other devices may be included to better describe the relevant embodiments. The apparatus may include any appropriate type of display panels, such as a plasma display panel, a liquid crystal display (LCD) panel, a touch screen display panel, a projection display panel, a non-smart display panel, a smart display panel, etc. The apparatus may also include other computing systems, such as a personal computer (PC), a tablet or mobile computer, or a smart phone, etc. In addition, the apparatus may be any appropriate content-presentation device capable of presenting any appropriate content. Users may interact with the apparatus to perform other activities of interest.

The processor 1002 may include any appropriate processor or processors. Further, the processor 1002 may include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 1012 may include various sensors and other I/O devices, such as keyboard and mouse.

Examples of appropriate apparatuses for detecting fingertip include, but are not limited to, an electronic paper, a mobile phone, a tablet computer, a television, a monitor, a notebook computer, a digital album, a GPS, etc. Optionally, the apparatus is an organic light emitting diode display apparatus. Optionally, the apparatus is a micro light emitting diode display apparatus. Optionally, the apparatus is a mini light emitting diode display apparatus. In one example, the apparatus for detecting fingertip is an interactive learning apparatus (e.g., so called point-and-read device) that is configured to detect a reader's fingertip, and configured to perform one or more function upon detecting the reader's fingertip, e.g., reading out the text where the fingertip is pointing to.

In some embodiments, the apparatus includes a memory; and one or more processors. Optionally, the memory and the one or more processors are connected with each other. Optionally, the memory stores computer-executable instructions for controlling the one or more processors to obtain a contour of a hand in the image; and perform finger detection on the contour to obtain finger position information. Optionally, to perform finger detection, the memory stores computer-executable instructions for controlling the one or more processors to perform a convex hull detection; perform a convex hull defect detection to obtain at least one convex hull defect, wherein a respective convex hull defect of the at least one convex hull defect comprises a far point, a first point, and a second point, the far point, the first point, and the second point being points on the contour; perform candidate finger search based on at least the far point and the second point to obtain the finger position information.

In some embodiments, to perform candidate finger search based on at least the far point and the second point to obtain candidate finger information, the memory further stores computer-executable instructions for controlling the one or more processors to assign the far point as a first root point; assign the second point as a top point; and search for a second root point. Optionally, to search for the second root point, the memory further stores computer-executable instructions for controlling the one or more processors to select a point on the contour as an updated candidate second root point.

In some embodiments, to perform candidate finger search based on at least the far point and the second point to obtain candidate finger information, the memory further stores computer-executable instructions for controlling the one or more processors to determine a first vector between the top point and the first root point; and determine a second vector between the top point and the updated candidate second root point.

In some embodiments, to perform candidate finger search based on at least the far point and the second point to obtain candidate finger information, the memory further stores computer-executable instructions for controlling the one or more processors to determine a magnitude of the second vector; and determine whether the magnitude of the second vector exceeds a minimum finger length.

In some embodiments, to perform candidate finger search based on at least the far point and the second point to obtain candidate finger information, the memory further stores computer-executable instructions for controlling the one or more processors to determine a cosine similarity between the first vector and the second vector; and determine whether the cosine similarity between the first vector and the second vector is greater than a maximum cosine similarity minus a second threshold value.

In some embodiments, to perform candidate finger search based on at least the far point and the second point to obtain candidate finger information, the memory further stores computer-executable instructions for controlling the one or more processors to traverse a plurality of points on the contour to determine whether or not conditions for a respective point of the plurality of points being the second root point are satisfied.

In some embodiments, to perform candidate finger search based on at least the far point and the second point to obtain candidate finger information, the memory further stores computer-executable instructions for controlling the one or more processors to determine a magnitude of the second vector; determine whether the magnitude of the second vector is greater than a maximum finger length; and upon determination that the magnitude of the second vector is greater than the maximum finger length, stop traversing the plurality of points on the contour.

In some embodiments, to perform candidate finger search based on at least the far point and the second point to obtain candidate finger information, the memory further stores computer-executable instructions for controlling the one or more processors to determine a cosine similarity between the first vector and the second vector; determine whether a finger has been detected; and upon determination that a finger has been detected, and the cosine similarity between the first vector and the second vector is less than the maximum cosine similarity minus the first threshold value, stop traversing the plurality of points on the contour.

In some embodiments, to perform candidate finger search based on at least the far point and the second point to obtain candidate finger information, the memory further stores computer-executable instructions for controlling the one or more processors to determine whether a finger has been detected; determine a magnitude of the second vector; determine whether the magnitude of the second vector exceeds a maximum finger width; and upon determination that a finger has not been detected, and the magnitude of the second vector exceeds the maximum finger width, stop traversing the plurality of points on the contour.

In some embodiments, to perform candidate finger search based on at least the far point and the second point to obtain candidate finger information, the memory further stores computer-executable instructions for controlling the one or more processors to determine a magnitude of the second vector; determine whether the magnitude of the second vector exceeds a minimum finger length; determine a cosine similarity between the first vector and the second vector; determine whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, update the updated candidate second root point to obtain a second updated candidate second root point, and update the maximum cosine similarity based on the cosine similarity between the first vector and the second vector (e.g., assign the cosine similarity between the first vector and the second vector as the maximum cosine similarity).

In some embodiments, to perform candidate finger search based on at least the far point and the second point to obtain candidate finger information, the memory further stores computer-executable instructions for controlling the one or more processors to determine a magnitude of the second vector; determine whether the magnitude of the second vector is greater than a maximum finger length; determine whether the magnitude of the second vector exceeds a maximum finger width; determine a cosine similarity between the first vector and the second vector; determine whether a finger has been detected; and determine whether any of the following three conditions are satisfied: the magnitude of the second vector is greater than the maximum finger length; or a finger has been detected, and the cosine similarity between the first vector and the second vector is less than the maximum cosine similarity minus the first threshold value; or a finger has not been detected, and the magnitude of the second vector exceeds the maximum finger width.

In some embodiments, to perform candidate finger search based on at least the far point and the second point to obtain candidate finger information, the memory further stores computer-executable instructions for controlling the one or more processors to, upon determination that none of the three conditions are satisfied; determine whether the magnitude of the second vector exceeds a minimum finger length; determine whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, update the updated candidate second root point to obtain a second updated candidate second root point, and update the maximum cosine similarity based on the cosine similarity between the first vector and the second vector (e.g., assign the cosine similarity between the first vector and the second vector as the maximum cosine similarity).

In some embodiments, to perform candidate finger search based on at least the far point and the second point to obtain candidate finger information, the memory further stores computer-executable instructions for controlling the one or more processors to update a coordinate of a fingertip point. In some embodiments, to update the coordinate of the fingertip point, the memory further stores computer-executable instructions for controlling the one or more processors to determine a line intersecting a first root point and a second root point of a candidate finger; determine a point on a contour of the candidate finger having a greatest distance from the line intersecting the first root point and the second root point; and assign the point on the contour of the candidate finger having the greatest distance from the line intersecting the first root point and the second root point as an updated finger top point.

In some embodiments, to perform candidate finger search based on at least the far point and the second point to obtain candidate finger information, the memory further stores computer-executable instructions for controlling the one or more processors to update a coordinate of a fingerroot point. In some embodiments, to update the coordinate of the fingerroot point, the memory further stores computer-executable instructions for controlling the one or more processors to determine a distance between the first root point and the top point of a candidate finger; determine a distance between a second root point and the top point of the candidate finger; and adjust coordinates of at least one of the first root point and the second root point until the distance between the first root point and the top point and the distance between the second root point and the top point are substantially the same. As used herein, in the step of updating the coordinate of the fingerroot point, the “top point” may be a second point detected during a convex hull defect detection, or may be the updated finger top point described above.

In some embodiments, to perform candidate finger search based on at least the far point and the second point to obtain candidate finger information, the memory further stores computer-executable instructions for controlling the one or more processors to fit a midline of a candidate finger.

In some embodiments, to fit the midline of the candidate finger, the memory further stores computer-executable instructions for controlling the one or more processors to determine a line intersecting a first root point and a second root point of the candidate finger; determine a finger area using the line intersecting the first root point and the second root point of the candidate finger and a contour of the candidate finger; and fit the midline of the finger area using an optimization algorithm.

In some embodiments, the memory further stores computer-executable instructions for controlling the one or more processors to perform finger deduplication on detected candidate fingers. Optionally, to perform finger deduplication on detected candidate fingers, the memory further stores computer-executable instructions for controlling the one or more processors to calculate an intersection over union of contours of two detected candidate fingers; and upon determination that the intersection over union of the contours of the two detected candidate fingers is greater than a threshold value, determine that the two detected candidate fingers are duplicates of a same candidate finger.

In some embodiments, to calculate the intersection over union of contours of two detected candidate fingers, the memory further stores computer-executable instructions for controlling the one or more processors to determine a first contour of a first detected candidate finger of the two detected candidate fingers including a first candidate root point, a second candidate root point, and a first candidate top point; determine a second contour of a second detected candidate finger of the two detected candidate fingers including a third candidate root point, a fourth candidate root point, and a second candidate top point; determine a first length of the first contour; determine a second length of the second contour; determine a third length of an intersection between the first contour and the second contour; and calculate the intersection over union of contours of two detected candidate fingers by

$$\frac{the third length}{min ( the first length , the second length )} .$$

In some embodiments, the memory further stores computer-executable instructions for controlling the one or more processors to perform a filtering process to remove false detection among detected fingers. Optionally, to perform a filtering process to remove false detection among detected fingers, the memory further stores computer-executable instructions for controlling the one or more processors to determine at least one of a candidate finger length by determining a distance between a candidate top point and a candidate root point; a candidate finger width by determining a distance between two candidate root points; or an aspect ratio of the candidate finger by dividing the candidate finger length by the candidate finger width.

In some embodiments, the memory further stores computer-executable instructions for controlling the one or more processors to assign the candidate finger as a falsely detected finger upon determination that the candidate finger length is less than a minimum finger length; assign the candidate finger as a falsely detected finger upon determination that the candidate finger width is greater than a maximum finger width; or assign the candidate finger as a falsely detected finger upon determination that the aspect ratio of the candidate finger is less than a minimum aspect ratio.

In another aspect, the present disclosure provides a computer-program product comprising a non-transitory tangible computer-readable medium having computer-readable instructions thereon. In some embodiments, the computer-readable instructions are executable by one or more processors to cause the one or more processors to perform obtaining a contour of a hand in the image; and performing finger detection on the contour to obtain finger position information. Optionally, performing finger detection comprises performing a convex hull detection; performing a convex hull defect detection to obtain at least one convex hull defect, wherein a respective convex hull defect of the at least one convex hull defect comprises a far point, a first point, and a second point, the far point, the first point, and the second point being points on the contour; performing candidate finger search based on at least the far point and the second point to obtain the finger position information.

In some embodiments, to perform candidate finger search based on at least the far point and the second point to obtain candidate finger information, the computer-readable instructions are executable by one or more processors to further cause the one or more processors to perform assigning the far point as a first root point; assigning the second point as a top point; and searching for a second root point. In some embodiments, to search for the second root point, the computer-readable instructions are executable by one or more processors to further cause the one or more processors to perform selecting a point on the contour as an updated candidate second root point.

In some embodiments, to perform candidate finger search based on at least the far point and the second point to obtain candidate finger information, the computer-readable instructions are executable by one or more processors to further cause the one or more processors to perform determining a first vector between the top point and the first root point; and determining a second vector between the top point and the updated candidate second root point.

In some embodiments, to perform candidate finger search based on at least the far point and the second point to obtain candidate finger information, the computer-readable instructions are executable by one or more processors to further cause the one or more processors to perform determining a magnitude of the second vector; and determining whether the magnitude of the second vector exceeds a minimum finger length.

In some embodiments, to perform candidate finger search based on at least the far point and the second point to obtain candidate finger information, the computer-readable instructions are executable by one or more processors to further cause the one or more processors to perform determining a cosine similarity between the first vector and the second vector; and determining whether the cosine similarity between the first vector and the second vector is greater than a maximum cosine similarity minus a second threshold value.

In some embodiments, to perform candidate finger search based on at least the far point and the second point to obtain candidate finger information, the computer-readable instructions are executable by one or more processors to further cause the one or more processors to perform traversing a plurality of points on the contour to determine whether or not conditions for a respective point of the plurality of points being the second root point are satisfied.

In some embodiments, to perform candidate finger search based on at least the far point and the second point to obtain candidate finger information, the computer-readable instructions are executable by one or more processors to further cause the one or more processors to perform determining a magnitude of the second vector; determining whether the magnitude of the second vector is greater than a maximum finger length; and upon determination that the magnitude of the second vector is greater than the maximum finger length, stopping traversing the plurality of points on the contour.

In some embodiments, to perform candidate finger search based on at least the far point and the second point to obtain candidate finger information, the computer-readable instructions are executable by one or more processors to further cause the one or more processors to perform determining a cosine similarity between the first vector and the second vector; determining whether a finger has been detected; and upon determination that a finger has been detected, and the cosine similarity between the first vector and the second vector is less than the maximum cosine similarity minus the first threshold value, stopping traversing the plurality of points on the contour.

In some embodiments, to perform candidate finger search based on at least the far point and the second point to obtain candidate finger information, the computer-readable instructions are executable by one or more processors to further cause the one or more processors to perform determining whether a finger has been detected; determining a magnitude of the second vector; determining whether the magnitude of the second vector exceeds a maximum finger width; and upon determination that a finger has not been detected, and the magnitude of the second vector exceeds the maximum finger width, stopping traversing the plurality of points on the contour.

In some embodiments, to perform candidate finger search based on at least the far point and the second point to obtain candidate finger information, the computer-readable instructions are executable by one or more processors to further cause the one or more processors to perform determining a magnitude of the second vector; determining whether the magnitude of the second vector exceeds a minimum finger length; determining a cosine similarity between the first vector and the second vector; determining whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector (e.g., assigning the cosine similarity between the first vector and the second vector as the maximum cosine similarity).

In some embodiments, to perform candidate finger search based on at least the far point and the second point to obtain candidate finger information, the computer-readable instructions are executable by one or more processors to further cause the one or more processors to perform determining a magnitude of the second vector; determining whether the magnitude of the second vector is greater than a maximum finger length; determining whether the magnitude of the second vector exceeds a maximum finger width; determining a cosine similarity between the first vector and the second vector; determining whether a finger has been detected; and determining whether any of the following three conditions are satisfied: the magnitude of the second vector is greater than the maximum finger length; or a finger has been detected, and the cosine similarity between the first vector and the second vector is less than the maximum cosine similarity minus the first threshold value; or a finger has not been detected, and the magnitude of the second vector exceeds the maximum finger width.

In some embodiments, to perform candidate finger search based on at least the far point and the second point to obtain candidate finger information, the computer-readable instructions are executable by one or more processors to further cause the one or more processors to perform, upon determination that none of the three conditions are satisfied: determining whether the magnitude of the second vector exceeds a minimum finger length; determining whether the cosine similarity between the first vector and the second vector is greater than a maximum cosine similarity minus a second threshold value; and upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector (e.g., assigning the cosine similarity between the first vector and the second vector as the maximum cosine similarity).

In some embodiments, to perform candidate finger search based on at least the far point and the second point to obtain candidate finger information, the computer-readable instructions are executable by one or more processors to further cause the one or more processors to perform updating a coordinate of a fingertip point. In some embodiments, to update the coordinate of the fingertip point, the computer-readable instructions are executable by one or more processors to further cause the one or more processors to perform determining a line intersecting a first root point and a second root point of a candidate finger; determining a point on a contour of the candidate finger having a greatest distance from the line intersecting the first root point and the second root point; and assigning the point on the contour of the candidate finger having the greatest distance from the line intersecting the first root point and the second root point as an updated finger top point.

In some embodiments, to perform candidate finger search based on at least the far point and the second point to obtain candidate finger information, the computer-readable instructions are executable by one or more processors to further cause the one or more processors to perform updating a coordinate of a fingerroot point. In some embodiments, to update the coordinate of the fingerroot point, the computer-readable instructions are executable by one or more processors to further cause the one or more processors to perform determining a distance between the first root point and the top point of a candidate finger; determining a distance between a second root point and the top point of the candidate finger; and adjusting coordinates of at least one of the first root point and the second root point until the distance between the first root point and the top point and the distance between the second root point and the top point are substantially the same. As used herein, in the step of updating the coordinate of the fingerroot point, the “top point” may be a second point detected during a convex hull defect detection, or may be the updated finger top point described above.

In some embodiments, to perform candidate finger search based on at least the far point and the second point to obtain candidate finger information, the computer-readable instructions are executable by one or more processors to further cause the one or more processors to perform fitting a midline of a candidate finger.

In some embodiments, to fit the midline of the candidate finger, the computer-readable instructions are executable by one or more processors to further cause the one or more processors to perform determining a line intersecting a first root point and a second root point of the candidate finger; determining a finger area using the line intersecting the first root point and the second root point of the candidate finger and a contour of the candidate finger; and fitting the midline of the finger area using an optimization algorithm. As used herein, in the step of updating coordinates of fingertip points, the “first root point” may be a far point detected during a convex hull defect detection, or may be an updated first root point updated during the candidate finger search. As used herein, in the step of updating coordinates of fingertip points, the “second root point” may be a second root point determined according to a step in the present method, or an updated second root point updated during the candidate finger search.

In some embodiments, the computer-readable instructions are executable by one or more processors to further cause the one or more processors to perform finger deduplication on detected candidate fingers. Optionally, performing finger deduplication on detected candidate fingers comprises calculating an intersection over union of contours of two detected candidate fingers; and upon determination that the intersection over union of the contours of the two detected candidate fingers is greater than a threshold value, determining that the two detected candidate fingers are duplicates of a same candidate finger.

In some embodiments, the computer-readable instructions are executable by one or more processors to further cause the one or more processors to perform determining a first contour of a first detected candidate finger of the two detected candidate fingers including a first candidate root point, a second candidate root point, and a first candidate top point; determining a second contour of a second detected candidate finger of the two detected candidate fingers including a third candidate root point, a fourth candidate root point, and a second candidate top point; determining a first length of the first contour; determining a second length of the second contour; determining a third length of an intersection between the first contour and the second contour; and calculating the intersection over union of contours of two detected candidate fingers by

$$\frac{the third length}{min ( the first length , the second length )} .$$

In some embodiments, the computer-readable instructions are executable by one or more processors to further cause the one or more processors to perform a filtering process to remove false detection among detected fingers. Optionally, performing a filtering process to remove false detection among detected fingers comprises at least one of determining a candidate finger length by determining a distance between a candidate top point and a candidate root point; determining a candidate finger width by determining a distance between two candidate root points; or determining an aspect ratio of the candidate finger by dividing the candidate finger length by the candidate finger width.

Optionally, performing a filtering process to remove false detection among detected fingers comprises at least one of assigning the candidate finger as a falsely detected finger upon determination that the candidate finger length is less than a minimum finger length; assigning the candidate finger as a falsely detected finger upon determination that the candidate finger width is greater than a maximum finger width; or assigning the candidate finger as a falsely detected finger upon determination that the aspect ratio of the candidate finger is less than a minimum aspect ratio.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A computer-implemented method of detecting fingertip in an image, comprising:
obtaining a contour of a hand in the image; and
performing finger detection on the contour to obtain finger position information;
wherein performing finger detection comprises:
performing a convex hull detection;
performing a convex hull defect detection to obtain at least one convex hull defect, wherein a respective convex hull defect of the at least one convex hull defect comprises a far point and a second point, the far point and the second point being points on the contour; and
performing candidate finger search based on at least the far point and the second point to obtain the finger position information.

2. The computer-implemented method of claim 1, wherein performing candidate finger search based on at least the far point and the second point to obtain candidate finger information comprises:
assigning the far point as a first root point;
assigning the second point as a top point; and
searching for a second root point;
wherein searching for the second root point comprises selecting a point on the contour as an updated candidate second root point.

3. The computer-implemented method of claim 2, wherein performing candidate finger search based on at least the far point and the second point to obtain candidate finger information further comprises:
determining a first vector between the top point and the first root point; and
determining a second vector between the top point and the updated candidate second root point.

4. The computer-implemented method of claim 3, wherein performing candidate finger search based on at least the far point and the second point to obtain candidate finger information further comprises:
determining a magnitude of the second vector; and
determining whether the magnitude of the second vector exceeds a minimum finger length.

5. The computer-implemented method of claim 3, wherein performing candidate finger search based on at least the far point and the second point to obtain candidate finger information further comprises:
determining a cosine similarity between the first vector and the second vector; and
determining whether the cosine similarity between the first vector and the second vector is greater than a maximum cosine similarity minus a second threshold value.

6. The computer-implemented method of claim 3, wherein performing candidate finger search based on at least the far point and the second point to obtain candidate finger information further comprises traversing a plurality of points on the contour to determine whether or not conditions for a respective point of the plurality of points being the second root point are satisfied.

7. The computer-implemented method of claim 6, wherein performing candidate finger search based on at least the far point and the second point to obtain candidate finger information further comprises:
determining a magnitude of the second vector;
determining whether the magnitude of the second vector is greater than a maximum finger length; and
upon determination that the magnitude of the second vector is greater than the maximum finger length, stopping traversing the plurality of points on the contour.

8. The computer-implemented method of claim 6, wherein performing candidate finger search based on at least the far point and the second point to obtain candidate finger information further comprises:
determining a cosine similarity between the first vector and the second vector;
determining whether a finger has been detected; and
upon determination that a finger has been detected, and the cosine similarity between the first vector and the second vector is less than the maximum cosine similarity minus the first threshold value, stopping traversing the plurality of points on the contour.

9. The computer-implemented method of claim 6, wherein performing candidate finger search based on at least the far point and the second point to obtain candidate finger information further comprises:
determining whether a finger has been detected;
determining a magnitude of the second vector;
determining whether the magnitude of the second vector exceeds a maximum finger width; and
upon determination that a finger has not been detected, and the magnitude of the second vector exceeds the maximum finger width, stopping traversing the plurality of points on the contour.

10. The computer-implemented method of claim 6, wherein performing candidate finger search based on at least the far point and the second point to obtain candidate finger information further comprises:
determining a magnitude of the second vector;
determining whether the magnitude of the second vector exceeds a minimum finger length;
determining a cosine similarity between the first vector and the second vector;
determining whether the cosine similarity between the first vector and the second vector is greater than a maximum cosine similarity minus a second threshold value; and
upon determination that the magnitude of the second vector is greater than the minimum finger length, and the cosine similarity between the first vector and the second vector is greater than the maximum cosine similarity minus the second threshold value, updating the updated candidate second root point, and updating the maximum cosine similarity based on the cosine similarity between the first vector and the second vector.

11. The computer-implemented method of claim 6, wherein performing candidate finger search based on at least the far point and the second point to obtain candidate finger information further comprises:
determining a magnitude of the second vector;
determining whether the magnitude of the second vector is greater than a maximum finger length;
determining whether the magnitude of the second vector exceeds a maximum finger width;
determining a cosine similarity between the first vector and the second vector;
determining whether a finger has been detected; and
determining whether any of the following three conditions are satisfied:
the magnitude of the second vector is greater than the maximum finger length; or
a finger has been detected, and the cosine similarity between the first vector and the second vector is less than the maximum cosine similarity minus the first threshold value; or
a finger has not been detected, and the magnitude of the second vector exceeds the maximum finger width;
wherein performing candidate finger search based on at least the far point and the second point to obtain candidate finger information further comprises, upon determination that none of the three conditions are satisfied:
determining whether the magnitude of the second vector exceeds a minimum finger length;
determining whether the cosine similarity between the first vector and the second vector is greater than a maximum cosine similarity minus a second threshold value; and
upon determination that the magnitude of the second vector is greater than the minimum finger length, and the cosine similarity between the first vector and the second vector is greater than the maximum cosine similarity minus the second threshold value, updating the updated candidate second root point to obtain a second updated candidate second root point, and updating the maximum cosine similarity based on the cosine similarity between the first vector and the second vector.

12. The computer-implemented method of claim 1, wherein performing candidate finger search based on at least the far point and the second point to obtain candidate finger information further comprises updating a coordinate of a fingertip point;
wherein updating the coordinate of the fingertip point comprises:
determining a line intersecting a first root point and a second root point of a candidate finger;
determining a point on a contour of the candidate finger having a greatest distance from the line intersecting the first root point and the second root point; and
assigning the point on the contour of the candidate finger having the greatest distance from the line intersecting the first root point and the second root point as an updated finger top point.

13. The computer-implemented method of claim 1, wherein performing candidate finger search based on at least the far point and the second point to obtain candidate finger information further comprises updating a coordinate of a fingerroot point;
wherein updating the coordinate of the fingerroot point comprises:
determining a distance between the first root point and the top point of a candidate finger;
determining a distance between a second root point and the top point of the candidate finger; and
adjusting coordinates of at least one of the first root point and the second root point until the distance between the first root point and the top point and the distance between the second root point and the top point are substantially the same.

14. The computer-implemented method of claim 1, wherein performing candidate finger search based on at least the far point and the second point to obtain candidate finger information further comprises fitting a midline of a candidate finger.

15. The computer-implemented method of claim 14, wherein fitting the midline of the candidate finger comprises:
determining a line intersecting a first root point and a second root point of the candidate finger;
determining a finger area using the line intersecting the first root point and the second root point of the candidate finger and a contour of the candidate finger; and
fitting the midline of the finger area using an optimization algorithm.

16. The computer-implemented method of claim 1, further comprising performing finger deduplication on detected candidate fingers;
wherein performing finger deduplication on detected candidate fingers comprises:
calculating an intersection over union of contours of two detected candidate fingers; and
upon determination that the intersection over union of the contours of the two detected candidate fingers is greater than a threshold value, determining that the two detected candidate fingers are duplicates of a same candidate finger.

17. The computer-implemented method of claim 16, wherein calculating an intersection over union of contours of two detected candidate fingers comprises:
determining a first contour of a first detected candidate finger of the two detected candidate fingers including a first candidate root point, a second candidate root point, and a first candidate top point;
determining a second contour of a second detected candidate finger of the two detected candidate fingers including a third candidate root point, a fourth candidate root point, and a second candidate top point;
determining a first length of the first contour;
determining a second length of the second contour;
determining a third length of an intersection between the first contour and the second contour; and
calculating the intersection over union of contours of two detected candidate fingers by
$$\frac{the third length}{min ( the first length , the second length )} .$$

18. The computer-implemented method of claim 1, further comprising performing a filtering process to remove false detection among detected fingers;
wherein performing a filtering process to remove false detection among detected fingers comprises at least one of:
determining a candidate finger length by determining a distance between a candidate top point and a candidate root point;
determining a candidate finger width by determining a distance between two candidate root points; or
determining an aspect ratio of the candidate finger by dividing the candidate finger length by the candidate finger width.

19. An apparatus for detecting fingertip in an image, comprising:
a memory; and
one or more processors;
wherein the memory and the one or more processors are connected with each other; and
the memory stores computer-executable instructions for controlling the one or more processors to:
obtain a contour of a hand in the image; and
perform finger detection on the contour to obtain finger position information;
wherein, to perform finger detection, the memory stores computer-executable instructions for controlling the one or more processors to:
perform a convex hull detection;
perform a convex hull defect detection to obtain at least one convex hull defect, wherein a respective convex hull defect of the at least one convex hull defect comprises a far point and a second point, the far point and the second point being points on the contour; and
perform candidate finger search based on at least the far point and the second point to obtain the finger position information.

20. A computer-program product, comprising a non-transitory tangible computer-readable medium having computer-readable instructions thereon, the computer-readable instructions being executable by a processor to cause the processor to perform:
obtaining a contour of a hand in the image; and
performing finger detection on the contour to obtain finger position information;
wherein performing finger detection comprises:
performing a convex hull detection;
performing a convex hull defect detection to obtain at least one convex hull defect, wherein a respective convex hull defect of the at least one convex hull defect comprises a far point and a second point, the far point and the second point being points on the contour; and
performing candidate finger search based on at least the far point and the second point to obtain the finger position information.
